(19) United States
(12) Patent Application Publication
(10) Pub. No.: US 2019/0251508 A1
(43) Pub. Date: Aug. 15, 2019

(54) SYSTEMS AND METHODS FOR FACILITATING FREIGHT TRANSPORTATION

(71) Applicant: Freightera Logistics Inc., Vancouver (CA)

(72) Inventor: Eric BECKWITT, Vancouver (CA)

(73) Assignee: Freightera Logistics Inc., Vancouver (CA)

(21) Appl. No.: 16/343,388

(22) PCT Filed: Oct. 20, 2017
(86) PCT No.: PCT/CA2017/051262

§ 371 Date: Apr. 18, 2019

Related U.S. Application Data
(60) Provisional application No. 62/411,442, filed on Oct. 21, 2016.

(51) Int. Cl. G06Q 10/08; G06Q 10/04; G01C 21/34

(52) U.S. Cl. CPC G06Q 10/08345; G01C 21/3423; G06Q 10/047; G06Q 10/08355

(57) ABSTRACT

A system for facilitating multi-modal freight transactions comprises a shipper portal for receiving a shipper input, a carrier portal for receiving a plurality of carrier inputs, a database storing information from the carrier inputs and the shipper input, and a processor configured to select and combine information from the plurality of carrier inputs within the database in response to the shipper input to generate a shipper output. The shipper output comprises a comparison of rates from carriers of all sizes and one of more options for freight transportation, the one or more options being selectable by the shipper for automatically booking freight transportation at a fixed cost.

### CROSS REFERENCE TO RELATED APPLICATION

This application claims the benefit of priority of U.S. Provisional Patent Application No. 62/411,442, filed Oct. 21, 2016, which is hereby incorporated herein by reference in its entirety.

### TECHNICAL FIELD

The present disclosure relates to the field of global freight transport and more specifically to facilitation of global freight transport transactions to minimize cost, reduce air pollution and greenhouse gas emissions, and increase efficiency.

### BACKGROUND

The global freight transportation industry is complex, involving different forms of transportation (including, for example, rail, road and air); many carriers, offering freight transportation services of different modes and to and from a multitude of locations; and shippers with a variety of freight requiring transportation.

The global freight transportation industry is currently highly inefficient and polluting. In North America an estimated 30% of the trucks on the road are empty due to lack of coordination and an efficient centralized marketplace for freight services. Approximately 80% of the trucks that are dispatched return empty. Furthermore, freight transport produces about 10% of the global greenhouse gases annually, and this is set to increase to up to 50% of global emissions by 2050.

There are several existing online sources of freight quotes, however, these fail to address the problems of inefficiency and pollution. Some systems offer quotes but only offer rates from the largest carriers, or offer only a limited number of small carries, or fail to integrate carriers to select an efficient route. In addition, carriers can be reluctant to share rate information with competitors and need an incentive to provide such data.

Existing systems for freight quoting generally fall into three classes: 1) systems that offer fixed cost quotes but only rates from the largest carriers (about 50-100 carriers total) via application programming interface (no central database or proprietary rate system, like Freightquote and FreightCenter); 2) smaller regional systems fixed cost system that offer rates from limited number of smaller carriers only (or smaller, skid based carriers with a few common carriers with density based rates); and 3) systems (like CargoChief, for example) that offer rates from multiple brokers and carriers with application programming interfaces.

The present disclosure is related to the subject matter of International patent application No. PCT/CA2014/000409 (published as WO 2014/176684), which is hereby incorporated by reference herein.

There exists a need for an online platform, where quoting and booking systems of carriers and logistics companies are integrated and shippers get the best available rates in real time, created automatically by routing shipments through multiple carriers, transport modes and intermediary locations, all presented seamlessly as a single fixed cost quote with tracking number and real-time status updates.

### DRAWINGS

The following figures set forth embodiments which are illustrated by way of example and not by way of limitation.

FIG. 1 is a flow chart illustrating steps of an example method carried out by a shipper portal of a freight shipping facilitation system according to one embodiment of the present invention.

FIG. 2 is a flow chart illustrating steps of an example method integrating different modes of freight transportation carried out by a freight shipping facilitation system according to one embodiment of the present invention.

FIG. 3 is a flow chart illustrating steps of an example method carried out by a carrier portal of a freight shipping facilitation system according to one embodiment of the present invention.

### DETAILED DESCRIPTION

Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

Embodiments of the present invention are directed to systems and methods for integration of various modes of freight transportation and availability. Certain embodiments provide freight shippers and carriers with a single, unified marketplace, integrating all forms of freight transportation, where shippers can instantly find the most efficient, least cost, and lowest emission option for each shipment, updated in real-time, and carriers can consolidate across companies and adjust prices in real-time to optimize loading of each truck for maximum efficiency and profit and minimal emissions.

Embodiments of the present invention may be configured to automatically generate rates in response to a query from a shipper entered into a Shipper Portal regarding a given load, specified by certain descriptors. The invention may also allow shippers to view rates for a given load, specified by certain descriptors, without the creation of an account.

Embodiments of the present invention may be configured to seamlessly integrate different modes of freight transport from different carriers to provide a shipper with rates for a selection of freight transportation options, including multi-modal options and multi-carrier options. Embodiments of the present invention may also seamlessly provide a shipper with the lowest rate option, or rates for options based on desired criteria. Embodiments of the present invention may permit a shipper to instantly book a transportation option.

Embodiments of the present invention may be configured to determine low emission (both greenhouse gasses and other air pollutants) transportation option(s) for transportation of a given load. Embodiments of the present invention may also seamlessly provide the shipper with the low emission option(s) in a response to a query into a Shipper Portal.

Embodiments of the present invention may be configured to integrate with carrier databases. Embodiments of the present invention may also be configured to permit carriers to enter or update information into a Carrier Portal. This will incentivize carriers by promoting efficiency and reducing pollution, including by permitting carriers to modify rates in order to fill freight transport vehicles (including, but not limited to trucks, trains and airplanes).

Embodiments of the present invention may be configured to automatically generate customs declaration forms, bills of lading, receipts and other documentation as required.

Embodiments of the present invention may be configured to operate on handheld devices. Embodiments of the present invention may also permit tracking of shipments and tracking of available space in a particular transport vehicle.

In one embodiment, the present invention provides an online system, hosted in the cloud, which is fully and seamlessly integrated with the live databases of the largest carriers and logistics companies in North America, and also with hundreds of smaller companies via a proprietary system of bulk rate input forms, web based input forms, web based rate update and editing forms, and a secure query system that simultaneously searches the databases of all integrated companies, and the system's central rate database, and gives B2B freight shippers access to the best rates and transit times in 15-20 seconds.

In one embodiment, the present invention provides a single, unified system that can provide B2B freight shippers with direct access to real-time fixed-cost all-inclusive rates from over 750,000 carriers in North America. The system is fully scalable and designed for global application. The system is configured to accommodate carriers representing multiple transportation modes (road, rail and air), and companies of all sizes (>10 k trucks, 1 k-10 k, 100-1000, 20-100, 5-20 and <5). Companies have different methods for storing and organizing rate data, including, in descending order of company size, application programming interfaces, class and National Freight NFMC code based rates, density based rates, skid and weight based rates, truckload rates, and no set rates. The current system has billions of freight lanes in North America (>12B and growing), covering 23,000 communities and including live rates from all carrier classes above. Depending on the carrier size and rate system used, the new platform either directly accesses existing carrier databases for real-time rates, availability, transit time and booking (with confirmation), or stores this information in a secure centralized database in a proprietary format only viewable to registered, confirmed shippers. In all cases, the same simplified front end system provides the quotes in 10-20 seconds, all shipping related documentation is instantly generated using the information entered at time of booking, and all documentation and the whole quote/booking process is available online 24/7.

In some implementations, the system gives B2B freight shippers comparative fixed cost all-inclusive quotes from the largest carriers, key regional carriers that have better rates than the largest revenue carriers, and many smaller carriers, down to owner operators with single trucks, that offer the best rates and service in the niche markets they serve. The system allows shippers to retrieve rates from all these carriers in 15-20 seconds using a single, password protected online account, and book the rate they want with a single click. Depending on the size of the carrier the booking is either automatically placed digitally via integration with the carrier's existing order process, or the carrier receives (and verifies) the booking via their own preferred electronic communication method. Carriers enter their rate by (in declining order of lanes in the system): 1) direct integration via application programming interface, 2) bulk upload of rates via proprietary density based rate interface, and 3) carrier enters skid based rates, availability and transit time via proprietary form based interface (less than 0.002% of rates are entered this way). Multiple transport modes (road, rail) are compared on the same page, allowing shippers to save more that 60% by selecting the rail option whenever it is available. Freight class is automatically calculated for all quotes, allowing shippers in Canada (who don't use freight class and don't know the class of their shipment) to still automatically receive rates from carrier that require class to calculate the correct quote. Complete integration with existing carrier load status systems provides automatically updated shipment status for certain shipments.

This new system provides a comprehensive, proprietary platform designed to integrate all carriers and logistics companies, across all transportation modes, into a single seamless global system that provides real-time fixed cost quotes between any two locations on earth in 15-20 seconds, and instant online booking. Further, this system is designed to use a single unified market to simultaneously reduce cost for shippers, increase profitability and efficiency for carriers, and promote the lowest emission shipping option and technologies, reducing greenhouse gas emissions and air pollution at the same time. This system allows shippers to compare all-inclusive fixed cost rates, on a single page, between transportation companies of all sizes, and book the rate instantly online. Finally, this system combines hand held applications, in IOS and Android format, which are in the trucks, warehouses and docks where the freight is picked up and delivered, and provide the ability for shippers to get rates, book and manage shipments from anywhere, the system to track empty and partially filled trucks so that shippers can book and fill them, and carriers can update load status by scanning bills of lading and RFID chips and automatically updating shipment location via the location of the truck linked app id.

Certain embodiments of the present invention may advantageously provide: 1) a freight quote system, or online freight marketplace, where B2B freight shippers can instantly compare fixed cost all-inclusive rates from carriers of all sizes and transportation modes. Systems according to some embodiments are configured to provide, in seconds, multiple comparative, instant or nearly instant all-inclusive rates for all transportation modes between any two locations on earth. Systems according to some embodiments allow instant booking, creating a binding, verified contract at the cost quoted, between the shipper and each of the various carriers regardless of carrier size or existing software or systems used by the carrier or logistics company. Systems according to some embodiments provide, region by region (i.e. North America, Europe, SE Asia etc.), not just rates from each carrier, logistics company, or transportation mode (ocean, air, rail, road) but also automatically created multiple stop connecting routes, via multiple carriers or logistics companies and transportation modes as necessary, but with a single, complete all-inclusive cost. When booked, such multi-mode, multi-company lanes are automatically booked as all intermediary companies automatically confirm booking, the load documentation shows as seamless move from origin to destination, and load status and location is automatically updated daily on a map showing progress of the shipment and which company has the load at each stage in the shipping process. Systems according to some embodiments automatically sort quote results by lowest emission (both greenhouse gases and air pollutants) by default. Frequently the lowest cost will also be the lowest emission option, allowing shippers to simultaneously reduce costs and greenhouse gas emissions at once. Determination of the lowest emission option will be completed by a proprietary set of algorithms that consider the equipment, transportation mode and technology used by each carrier, and the emissions per distance of each segment the load travels.

A system according to certain embodiments of the present invention advantageously: 1) allows the smallest carriers, down to a single vehicle, to post their rates into a common marketplace and compete on price, travel time and availability, with the largest, multinational carriers and logistics companies (previous patent applications included rates from small and large carriers in common carrier/density based format, but not the ability to compare rates from the largest carriers in the world, with comprehensive rates available online only via application programing interface, with rates hand entered by the smallest carriers other companies that only offer skid based pricing); 2) integrates proprietary apps, for IOS and Android, that will allow the system to track the real-time location of hundreds of thousands of trucks, and identify, like an air traffic control center, which companies have empty trucks in or approaching a given community on a given day, allowing shippers to book these vehicles and fill what would normally be an empty backhaul.

Certain embodiments of the system provide the core functionality to allow carriers of all sizes to post their rates in a single market, regardless of the native rate format or how rates are normally calculated, stored or retrieved by the firm.

Certain embodiments of the system provide varying levels of service for carriers, from free accounts to paid accounts and advertising, with differing levels of support. For carriers with small budgets all rate entry, load management and rate updates can be done 100% by the carrier using a free account. Larger firms can opt to have rates uploaded or maintained by admins in the system, and for the largest firm system developers can be retained to integrate their application programming interface with the system for instant quotes, automated booking in their systems, and automated load status updates.

Certain embodiments of the system provide a subsystem or a separate system of advertising, using display or pay for click model, wherein the carrier can post for their rates or service alongside the “organic” results from the rate queries.

Certain embodiments of the system provide multiple levels of shipper accounts, from free to high cost per month, which allows larger shippers to outsource to the system admins complete management of the whole shipping process, and also receive higher standards of care, lower markups on each load (in exchange for a monthly service fee) and higher levels of care and automatic cargo insurance for each load.

Certain embodiments of the system provide carriers with access to load demand posted by B2B freight shippers, allowing carriers to match prices set by shippers, or bid in a reverse auction format for the loads.

Certain embodiments of the system provide a particular fee based option (“Freightera direct”) for carriers, which may be implemented for example as a separate system or subsystem, and which allows carriers to pay to be listed, or pay a referral fee for all loads booked. In such a system, payments would be passed through to the carrier with no markup, but the carrier, not the system operator would provide all customer service, load status updates, and support. In some embodiments customers would be able to select either a default system or Freightera direct at signup, but not switch between systems. Carriers would solely responsible in Freightera direct for collecting any additional payments due from the shippers due to inaccurate information or extra services required during pickup, transit or delivery, and the system operator's sole responsibility and service in Freightera direct would be connecting the shipper to the carrier, and passing the funds directly from shipper to carrier.

Certain embodiments of the system provide automated notification of full truckload carriers, via email, SMS or Iphone or Android App as preferred, when full truckload or large less than truckload loads are posted to the system on lanes the carrier has previously agreed they want to cover. This includes carriers ability to set a “blind” rate (hidden to the shipper), and the shipper their own “blind” rate (hidden to the carrier), where the rates match the shipment is booked and carrier selected and assigned.

Certain embodiments of the system also automatically assemble complete, all-inclusive rate quotes for global shipments from individual route segments, regardless of transportation mode, creating a single booking spanning multiple transport companies and transport modes, automatically creates all shipping documentation including customs documents, and notifies all parties in the transaction that the load is booked, or if changes in delivery dates or other pertinent transit related issues occur while the freight is being moved.

Known systems use carbon credits and offsets to claim reduction in greenhouse gas emissions, but systems according to certain embodiments of the present disclosure reduce emissions with every shipment by redirecting freight to existing transport modes and traction technologies that reduce emissions up to 80% on each load transported. By continually redirecting freight traffic to the lowest cost/lowest emission options, the system stimulates the rapid adoption of new, even lower emission transport technologies. Provided that zero emission technologies could cost even less for transportation than existing low emission transport modes, this process may continue until most of land, sea and air transport is much less expensive and zero or near zero emission.

Systems according certain embodiments of the present disclosure are designed specifically for providing automated quotes for refrigerated less than full and full truckload service, flatbed truckload service, full and half containers of all sizes, intermodal rates to communities never before served by these typically lower rates, and integrate road/rail/ocean service that connect all major commercial and manufacturing centers on earth, including full integrated automatic generation of all customs documentation.

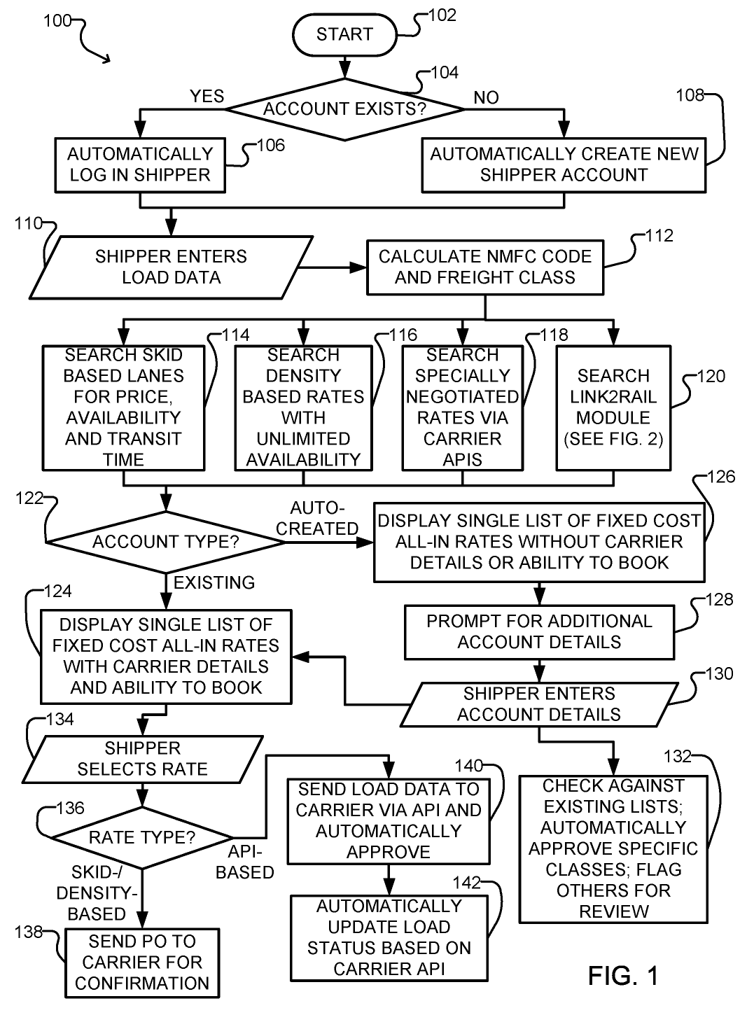

FIG. 1 is a flow chart illustrating steps of an example method 100 carried out by a shipper portal of a freight shipping facilitation system according to one embodiment of the present invention. Method 100 begins at block 102 when a user (sometimes referred to herein as a “shipper”) accesses the shipper portal, for example through a website or mobile application or other means. At block 104 the system determines if the user is associated with an existing shipper account (block 104 YES output), in which case the system automatically logs the shipper in at block 106, or not (block 104 NO output), in which case the system automatically creates a new shipper account at block 108. Creating a new shipper account comprises generating an account number, so that quotes made without logging in are stored and associated with the account number for the new shipper when a corresponding full account is created as described below.

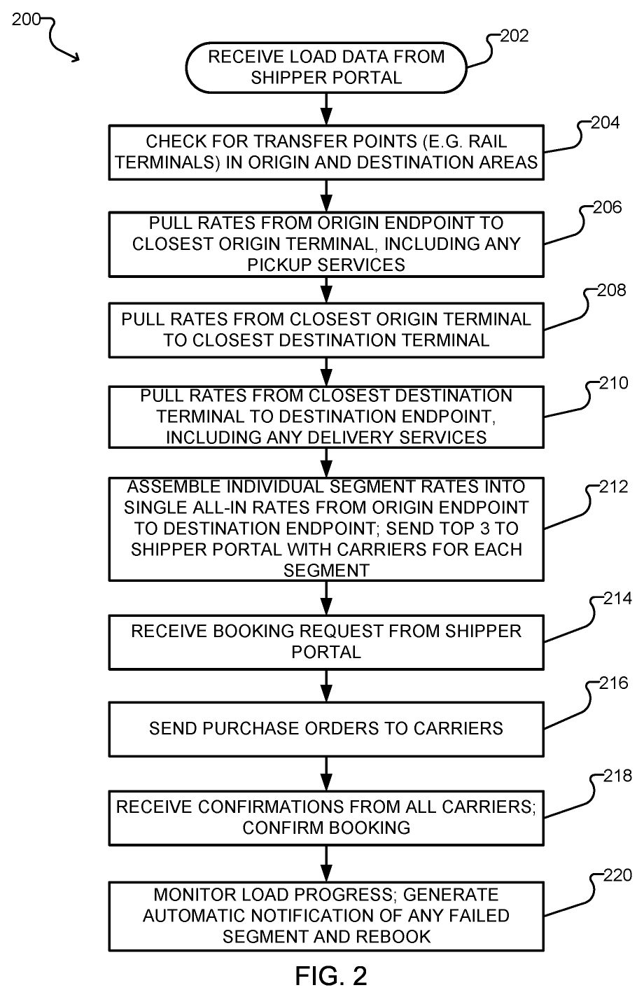

After block 106/108, the system proceeds to block 110 wherein the shipper enters load data, including origin and destination endpoints and other information about the load to be shipped such as weight, density, dimensions, and type of material. At block 112 the system calculates a National Motor Freight Classification (NMFC) code, then proceeds to conduct a plurality of searches at blocks 114, 116, 118 and 120. The searches at blocks 114, 116, 118 and 120 may, for example, be conducted among rates obtained from a shipper portal as described below. At block 114 the system searches skid based rates for price, availability and transit time. At block 116 the system searches density based rates having unlimited ability. At block 118 the system searches for specially negotiated rates from carrier application programming interfaces (APIs). At block 120 the system searches for rates using a Link2Rail module as described below with reference to FIG. 2.

At block 122 the system checks the account type. If the shipper has an existing account the system proceeds to block 124 and displays a list of fixed cost all-inclusive rates with carrier details, and provides the shipper with the ability to select any of the rates for booking. If the shipper has a new auto-created account the system displays a similar rate list at block 126 but without carrier details or the ability to book, and prompts the shipper to enter additional details at block 128. At block 130 the system receives at least the minimum necessary data for a valid shipper account (i.e., name, address, phone, password), then the system proceeds to block 124, pending activation at block 132.

At block 132, an administrator reviews the shipper account prior to activation and verifies that the new account represents a real business shipper, not a carrier, competitor, fake account or personal shipper. Only verified business to business shippers (including cooperating logistics companies and freight forwarders). In some embodiments, businesses identified in new shipper accounts will be checked against existing business lists (such as Industry Canada) and automatically approved if there are in certain business categories (e.g. manufacturing, distribution, importers, warehouses, and retailers).

After block 124, the shipper selects one of the displayed rates for booking at block 134 and the system determines the rate type at block 136. If the selected rate is skid or density based the system sends one or more purchase order(s) (PO(s)) to the carrier(s) for confirmation at block 138. If the selected rate is API based the system sends the load data to the carrier(s) by means of the API and automatically approves the booking at block 140. At block 142 the system automatically updates load status based on information from the carrier API.

FIG. 2 is a flow chart illustrating steps of an example method 200 integrating different modes of freight transportation carried out by a freight shipping facilitation system according to one embodiment of the present invention. Method 200 begins at block 202 when the system receives load data from the shipper portal. At block 204 the system checks for transfer points (e.g. rail terminals, docks or other shipping terminals, etc.) to determine suitable transfer points near the origin and destination endpoints for the load. At block 206 the system pulls rates for transporting the load from the origin endpoint to the closest terminal to the origin endpoint, or one or more relatively close terminals (each referred to as an “origin terminal”), and also any rates for any pickup services specified in the load data. At block 208 the system pulls rates for transporting the load from an origin terminal to the closest terminal to the destination endpoint, or one or more relatively close terminals (each referred to as a “destination terminal”). At block 210 the system pulls rates for transporting the load from a destination terminal to the destination endpoint, and also any rates for any delivery services specified in the load data.

Once the above rates have been obtained, at block 212 the system assembles the rates for the individual segments into a plurality of single, all-inclusive rates for transportation from the origin endpoint to the destination endpoint, and sends a selection thereof (e.g., the top 3 all-inclusive rates, as ranked by cost, emissions and/or timing) to the carrier portal, along with carrier details for each segment. At block 214 the system receives a booking request from the shipper portal (e.g. by a shipper selecting a rate at block 134 of FIG. 1). At block 216, the system sends purchase orders to the carriers for each segment (e.g. as in block 138 of FIG. 1, or block 140 where the carrier's API is available). At block 218 the system receives confirmations from all carriers and confirms the booking to the shipper. At block 220 the system monitors load progress during transport (e.g. as in block 142 of FIG. 1) and generates notification of any delays or other problems. The system also automatically re-books any failed segments at block 220.

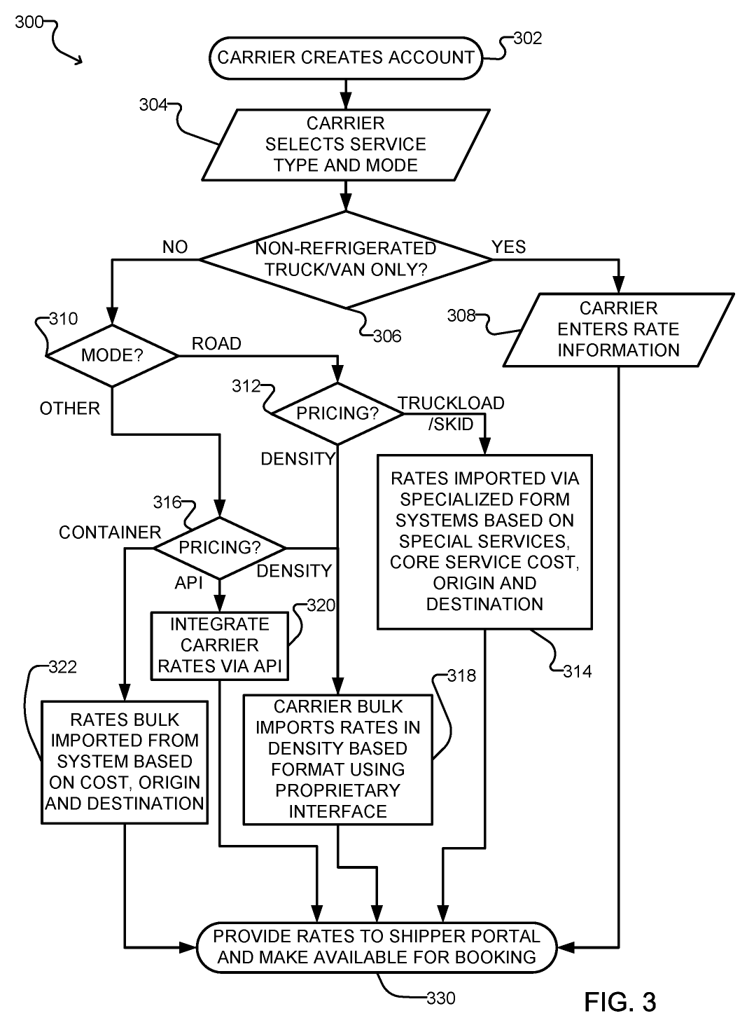

FIG. 3 is a flow chart illustrating steps of an example method 300 carried out by a carrier portal of a freight shipping facilitation system according to one embodiment of the present invention. Method 300 begins at block 302 when a carrier creates an account in the system. At block 304 the carrier selects the type(s) of service and mode(s) of transportation they are offering, which are checked by the system at block 306. If the selected type/mode is only non-refrigerated trucks/vans or the like (block 306 YES output), the carrier enters their rate information at block 308, then the system provides the rates to the shipper portal and makes them available for booking at block 330. If the selected type/mode includes other modes/types (block 306 NO output), then the system determines which mode(s) of transportation are being offered at block 310.

If the transportation mode is road (block 310 ROAD output) the system checks the pricing offered by the carrier for the selected service type at block 312. If the transportation mode is not road (block 310 OTHER output) the system checks the pricing offered by the carrier for the selected service type at block 316. For road transportation and truckload or skid-based priding (block 312 TRUCKLOAD/SKID output), at block 314 the system has the carrier create specially formatted files for truckload and skid (less than truckload) rates, allowing mass import even for the smallest carriers. This will greatly speed the lane import process, and also allow them to export their old lanes, review them all quickly in a spreadsheet, and upload the correct rates again (for the next year, month, or any other period). The system then provides the rates to the shipper portal and makes them available for booking at block 330.

For road transportation and density based pricing (block 312 DENSITY output), or for other transportation and density based pricing (block 316 DENSITY output), the carrier bulk imports rates into the system at block 318 using a proprietary interface that allows full truckload, and refrigerated full truckload and less than truckload density based rates to be easily imported, managed and updated, also including multiple special services and transportation modes.

For other transportation and API based pricing (block 316 API output), the system integrates the carrier's rates via the carrier's API at block 318, then the system provides the rates to the shipper portal and makes them available for booking at block 330. For other transportation and container based pricing (block 316 CONTAINER output), the system bulk imports the container based rates at block 322, then the system provides the rates to the shipper portal and makes them available for booking at block 330.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and systems and methods implemented by electronic machines and systems adapted for processing and transforming electromagnetic signals which represent freight shipping rate information to facilitate efficient freight transport.

The present invention may be embodied in other specific forms without departing from its essential characteristics. The described embodiments are to be considered in all respects only as illustrative and not restrictive.

1. A system for facilitating multi-modal freight transactions comprising:
a shipper portal for receiving a shipper input;
a carrier portal for receiving a plurality of carrier inputs;
a database storing information from the carrier inputs and the shipper input; and
a processor configured to select and combine information from the plurality of carrier inputs within the database in response to the shipper input to generate a shipper output comprising a comparison of rates from carriers of all sizes and one of more options for freight transportation, the one or more options being selectable by the shipper for automatically booking freight transportation at a fixed cost.

2. The system of claim 1 wherein the processor determines emissions for each of a plurality of shipment segments and automatically selects a lowest emission shipping option for the shipper output.

3. The system of claim 2 wherein the shipper output includes automatically generated customs forms and related documentation.

4. The system of claim 3 wherein the processor automatically calculates a freight class based on the shipper input.

5. The system of claim 4 wherein the database automatically imports common carrier rates.

6. The system of claim 1 wherein the processor carries out an instant comparison of rates in the database from carriers of all sizes (largest logistics companies, common carriers, regional firms and owner operators) by aggregating online rates and comparing them.

7. The system of claim 1 comprising a Link2Rail system providing automated access for all carriers of all sizes to rail yards for expanding the reach of intermodal freight.

8. The system of claim 1 wherein the database includes carrier inputs from multiple modes (air, ocean, rail, road) of transportation and the processor determines options for shipper output through optimization of all of the modes of transport.

9. The system of claim 8 wherein the processor allows integrated quotes from multiple companies, where one moves freight to a distribution center and another warehouses and distributes it, all as part of a fixed all-inclusive quote generated as the shipper output.

10. The system of claim 9 wherein a specific carrier for the freight transportation is not specified but the fixed cost comprises an all-inclusive guaranteed quote.

11. The system of claim 10 wherein the shipper output includes a 100% damage/loss prevention system where shipper is completely protected from loss due to damage in transit, and receives immediate payout if valid claim submitted.

12. The system of claim 1 wherein the database includes the location of empty trucks automatically uploaded via geo-positioning application for IOS and Android and available for inclusion in shipper output.

13. The system of claim 12 wherein the shipper output includes real-time tracking of all shipments via IOS/Android App.

14. The system of claim 13 wherein shipper output includes automated fixed cost quotes and instant bookings for refrigerated (truckload and less than truckload), flatbed and container loads.

15. The system of claim 1 wherein multiple shipments from the same location are automatically consolidated, transferred to a distribution center by full truckload, and sent directly to their respective destinations from the distribution center.

16. The system of claim 1 wherein the loads are automatically consolidated between carriers so that one firm runs a full truck on the lane each day, and the other firm does not dispatch a vehicle on that lane that day because 100% of the freight has been transferred, wherein selection of carriers is determined by predefined contract rules set up between carriers using the system.

17. The system of claim 1 wherein the shipper output includes emission information to allow shippers to reduce air pollution and greenhouse gas emissions from freight shipping.

18. The system of claim 16 wherein the database also tracks air pollutants and greenhouse gas emissions from each carrier, as reported using government and non-government emissions tracking and reduction systems, so that shipper can select the lowest emission option by pollutant or an index of several pollutants.

19. The system of claim 1 wherein carriers are able to select if they want to be included in a brokerage system, at no cost for basic listing but with a markup applied, or a directory system, where they pay a listing fee, or agree to a referral fee for each load, but have no markup on their rates.

20. The system of claim 1 wherein shippers are provided with an option to select between:
a) a brokerage system, where the shipper pays a markup on carrier rates in exchange for non-carrier customer service, load tracking, insurance, and intervention in the event of carrier not invoicing as quoted; or
b) a direct model system, where the shipper gets carrier direct rates, but have only carrier direct customer service, and the direct model system serves as a passthrough for payments and matching service identifying the best carriers to use each time, with carrier rating from the brokerage system also showing in the direct systems.
